(19) United States
(12) Patent Application Publication
(10) Pub. No.: US 2013/0034824 A1
(43) Pub. Date: Feb. 7, 2013

(54) DENTAL LIGHT CURING DEVICE WITH IMPROVED HEAT DISSIPATING MECHANISM

(71) Applicants: SHAN-NON WANG, Taoyuan County (TW); JI-HON LIN, Taoyuan County (TW)

(72) Inventors: SHAN-NON WANG, Taoyuan County (TW); JI-HON LIN, Taoyuan County (TW)

(73) Assignee: ROLENCE ENTERPRISE INC., TAOYUAN COUNTY (TW)

(21) Appl. No.: 13/242,318

(22) Filed: Sep. 23, 2011

(30) Foreign Application Priority Data
Aug. 1, 2011 (TW) 100214160

(51) Int. Cl. A61C 5/04

(52) U.S. Cl. 433/29

(57) ABSTRACT

A light curing device used to solidify resin with a particular wavelength of beam comprising a shell, a heat sink, a light curing device and an air guide unit. The shell has an air inlet at the extremity and several air outlets around the side wall thereof. The heat sink is inside the shell. The light source device which is disposed inside the shell and at another extremity has at last one light unit closed the heat sink. The air guide unit is disposed inside the air inlet. The light curing device adapts an improved cooling structure to increase cooling efficiency, reduce the noise and vibration, and reduce unit weight.

### BACKGROUND OF THE INVENTION

1. Field of the Invention

The instant disclosure relates to a light curing device; more particularly, to a light curing device having improved cooling mechanism.

2. Description of Related Art

The major purpose for a light curing device in dentistry is used light or heat to solidify the filler in the tooth. To increase the convenience of operation, the light curing devices are developed to be the handheld size.

Moreover, the light curing device comprises a heat unit like light source or heat source, overheats more often and damages the handheld device, especially in a small one, so that a fan was disposed inside to force air convection to take the heat away and cool the device. This kind of device has some defects in using:

1. Wind noise and low frequency operation noise happened when the fan was in working, that means it isn't suitable to use the handheld solidification device having a fan inside in a quiet environment.

2. Occupation injury happen easily under a long-term of time because of the vibration from the fan.

3. The fan disposed in the handheld device was drove by a power supply inside, like a battery, so that weight the handheld device and make the user feel tired more when operating.

4. Limited by the size of the handheld device, the fan is small with poor cooling efficiency and the handheld device overheats easily so that user has to stop working for cooling and extend the work period.

### SUMMARY OF THE INVENTION

The instant disclosure provides a light curing device used to solidify resin with a particular wavelength of beam by the improved cooling structure to raise the cooling efficiency, to reduce the noise and vibration, to be lightweight than traditional type.

The instant disclosure provides a light curing device comprising a shell, a heat sink, a light source unit and an air guide unit. The shell has an air inlet at the extremity and several air outlets around it. The heat sink is arranged inside the shell. The light curing device which is disposed inside the shell and at another extremity has at last one light unit closed the heat sink. The air guide unit is disposed in the air inlet.

The instant disclosure has the following advantage: in this instant, forced airflow transmitted from the air supply instead of the fan inside the traditional light curing device. Power supply drives the control device electrically instead of the power source inside the traditional light curing device. These advantages are 1. Lightweight without fan and power source inside is easier to handheld for the medical staff; 2. High cooling efficiency and power supply make the light curing device working for a long time without breaking off the medical practice in overheating or not enough power.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is an isolate view which the light curing device connected to the tube.

FIG. 2 is an exploded view of the light curing device.

FIG. 3 is a section view of the light curing device.

FIG. 4 is another section view of the light curing device.

### DETAILED DESCRIPTION OF PREFERRED EMBODIMENTS

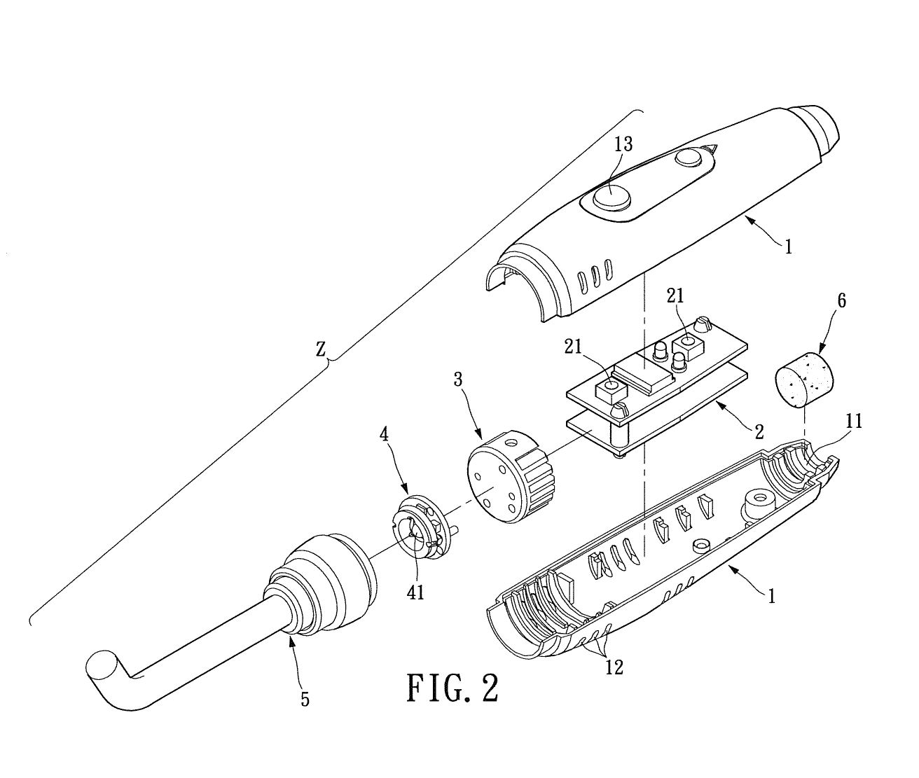

Please refer to FIGS. 2, which show a light curing device Z used to solidify resin with a particular wavelength of beam, comprising a shell 1, a heat sink 3, a light curing device 4 and an air guide unit 6.

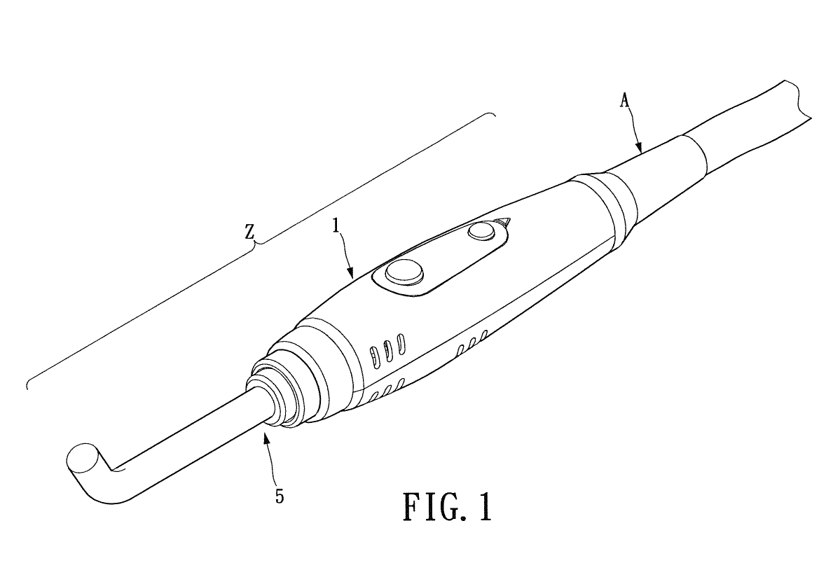

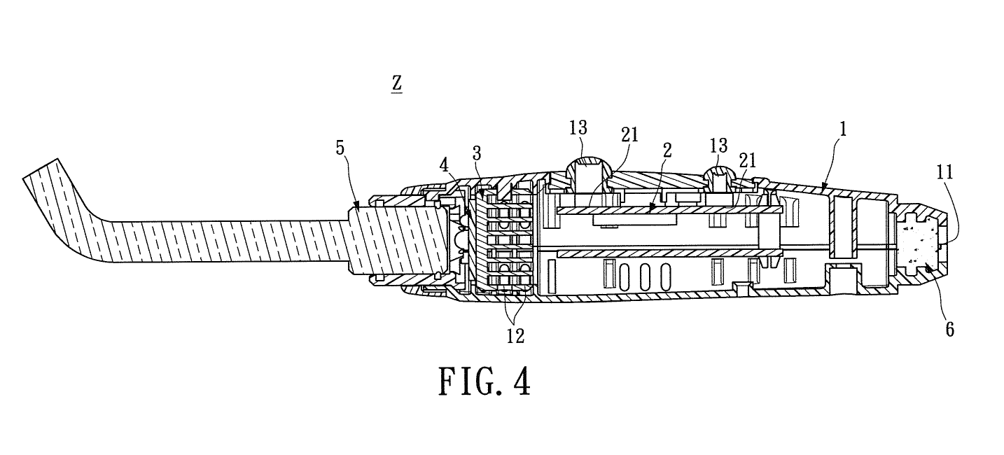

As shown in FIG. 1 and FIG. 4, the shell 1 is a handheld shape like a pen body, having an air inlet 11 at the extremity and several air outlets 12 around the shell 1. The air inlet 11 connected to power from the power supply and forced airflow from a tube A, formed several airways between the air outlet 12 and it so that the forced airflow passed through the light curing device Z, took heat away and cool in this instant disclosure.

Forced airflow produces turbulent flow easily, makes abnormal vibration and noise. In order to cool effectively, the air guide unit 6 was disposed inside the air inlet 11. The air guide unit 6 is a porosity structure like a sponge in this embodiment but not limited thereto so that the turbulent flow appeared less and less when forced airflow passes through the air guide unit 6 and got the higher cooling effect.

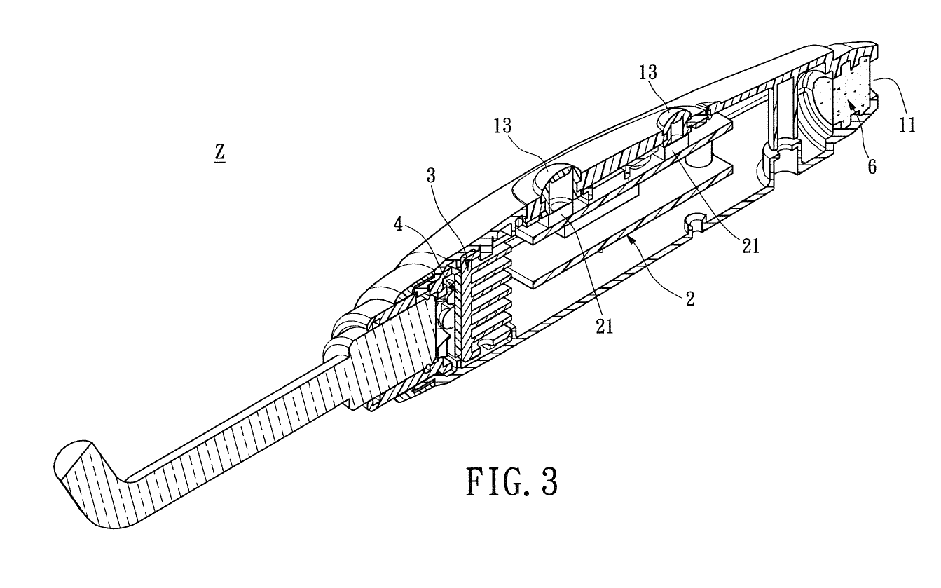

As shown in FIG. 2 to FIG. 4, a control device 2 which is one or several stacked substrates was disposed inside the shell 1, comprising at last one input port 21 connected to the operation interface 13 of the shell 1. Users operate on the operation interface 13 and order the control device 2 to control a light source unit 4 of the light curing device Z.

The light source unit 4 was disposed inside the shell 1 and closed at another extremity of it having at last one light unit 41 connected to the control device 2 electrically. The better embodiment of the light unit 41 has a major blue light emitting diode and a white light emitting diode supportively. The light unit 41 is the major heat source so that it was pressed close to the heat sink 3. Furthermore, the forced airflow from the air inlet 11 took the heat away from the heat sink 3 which disposed in the shell 1 and closed to some or all of the air outlets 12 is high thermal conductivity, left the light curing device Z from the outlets 12 near the heat sink 3 finally.

An optical transmission unit 5 was disposed at another extremity of the shell 1 used for transmitting the beam from light source unit 4 to the resin.

Generally, there are many kind of air supplies and power supplies to connect or drive medical equipment in medical station.

In this instant, forced airflow transmitted from the air supply instead of the fan inside the traditional light curing device. Power supply drive the control device electrically instead of the power source inside the traditional light curing device. These advantages are 1. Lightweight without fan and power source inside is easier to handheld for the medical staff; 2. High cooling efficiency and power supply make the light curing device working for a long time without breaking off the medical practice in overheating or not enough power.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

1. A light curing device used to solidify light curable resin with a particular wavelength, comprising:
a generally elongated shell having an air inlet arranged at the first end thereof and a plurality of air outlets arranged around the sidewall thereof,
a heat sink arranged in the shell,
a light source unit disposed inside the shell proximate the second end having at last one light unit disposed near the heat sink, and
a sponge disposed inside the air inlet in alignment with the heat sink and the light source unit for reducing turbulent airflow, thereby reducing noise level.

2. The light curing device of claim 1, wherein the air inlet connect a tube.

3. (canceled)

4. (canceled)

5. The light curing device of claim 1, wherein the heat sink is close to more than one of the air outlets.

6. The light curing device of claim 1, furthermore comprising a control device disposed inside the shell.

7. The light curing device of claim 6, wherein the control device connected to the at last one light unit electrically.

8. The light curing device of claim 6, wherein the control device comprises at last one input port.

9. The light curing device of claim 8, wherein the at last one port connect to an operation interface on the shell.

10. The light curing device of claim 1, wherein an optical transmission unit was disposed at the second end of the shell.

11. The light curing device of claim 10, wherein the optical transmission unit transmitted the beam from the light source unit to the resin.
